(19) United States
(12) Patent Application Publication
(10) Pub. No.: US 2025/0063533 A1
(43) Pub. Date: Feb. 20, 2025

(54) SIDELINK POSITIONING REFERENCE SIGNAL RESOURCE CANCELLATION

(71) Applicant: QUALCOMM Incorporated, San Diego, CA (US)

(72) Inventors: Srinivas YERRAMALLI, San Diego, CA (US); Piyush GUPTA, Bridgewater, NJ (US); Alexandros MANOLAKOS, Athens (GR); Mukesh KUMAR, Hyderabad (IN)

(21) Appl. No.: 18/721,506

(22) PCT Filed: Nov. 30, 2022
(86) PCT No.: PCT/US2022/080648

§ 371 Date: Jun. 18, 2024

(30) Foreign Application Priority Data
Jan. 13, 2022 (GR) 20220100027

(51) Int. Cl. H04W 64/00; H04W 72/231; H04W 72/25; H04W 92/18

(52) U.S. Cl. CPC H04W 64/00; H04W 72/231; H04W 72/25; H04W 92/18

(57) ABSTRACT

Disclosed are techniques for wireless positioning. In an aspect, a network entity may determine that at least one sidelink positioning reference signal (SL-PRS) resource should be cancelled or rescheduled. The network entity may send, to at least one user equipment (UE), a sidelink cancellation indication (SLCI) indicating the at least one SL-PRS resource to be cancelled or rescheduled. In another aspect, a UE may determine that at least one SL-PRS resource should be cancelled or rescheduled. The UE may cancel or reschedule the at least one SL-PRS resource.

### CROSS-REFERENCE TO RELATED APPLICATIONS

The present application for patent claims the benefit of GR Application No. 20220100027, entitled “SIDELINK POSITIONING REFERENCE SIGNAL RESOURCE CANCELLATION”, filed Jan. 13, 2022, and is a national stage application, filed under 35 U.S.C. § 371, of International Patent Application No. PCT/US2022/080648, entitled, “SIDELINK POSITIONING REFERENCE SIGNAL RESOURCE CANCELLATION”, filed Nov. 30, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a network entity includes determining that at least one sidelink positioning reference signal (SL-PRS) resource should be cancelled or rescheduled; and sending, to at least one user equipment (UE), a sidelink cancellation indication (SLCI) indicating the at least one SL-PRS resource to be cancelled or rescheduled.

In an aspect, a method of wireless communication performed by a first UE includes determining that at least one SL-PRS resource should be cancelled or rescheduled; and cancelling or rescheduling the at least one SL-PRS resource.

In an aspect, a network entity includes a memory; at least one transceiver; and at least one processor communicatively coupled to the memory and the at least one transceiver, the at least one processor configured to: determine that at least one SL-PRS resource should be cancelled or rescheduled; and send, via the at least one transceiver, to at least one UE, a SLCI indicating the at least one SL-PRS resource to be cancelled or rescheduled.

In an aspect, a UE includes a memory; at least one transceiver; and at least one processor communicatively coupled to the memory and the at least one transceiver, the at least one processor configured to: determine that at least one SL-PRS resource should be cancelled or rescheduled; and cancel or reschedule the at least one SL-PRS resource.

In an aspect, a network entity includes means for determining that at least one SL-PRS resource should be cancelled or rescheduled; and means for sending, to at least one UE, a SLCI indicating the at least one SL-PRS resource to be cancelled or rescheduled.

In an aspect, a UE includes means for determining that at least one SL-PRS resource should be cancelled or rescheduled; and means for canceling the at least one SL-PRS resource.

In an aspect, a non-transitory computer-readable medium storing computer-executable instructions that, when executed by a network entity, cause the network entity to determine that at least one SL-PRS resource should be cancelled or rescheduled, and send, to at least one UE, a SLCI indicating the at least one SL-PRS resource to be cancelled or rescheduled.

In an aspect, a non-transitory computer-readable medium storing computer-executable instructions that, when executed by a UE, cause the UE to determine that at least one SL-PRS resource should be cancelled or rescheduled, and cancel or reschedule the at least one SL-PRS resource.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram of an example positioning reference signal (PRS) configuration for the PRS transmissions of a given base station, according to aspects of the disclosure.

FIG. 6 illustrates an example of a wireless communications system that supports unicast sidelink establishment, according to aspects of the disclosure.

FIG. 7 is a diagram illustrating an example sidelink ranging and positioning procedure, according to aspects of the disclosure.

FIG. 8A through FIG. 8E are signal and event diagrams illustrating examples of SL-PRS resource cancellation in SL Mode 1, according to aspects of the disclosure.

FIG. 9A through FIG. 9C are signal and event diagrams illustrating examples of SL-PRS resource cancellation in SL Mode 2, according to aspects of the disclosure.

FIG. 10 is a flowchart of an example process, performed by a base station or other network entity, associated with SL-PRS resource cancellation, according to aspects of the disclosure.

FIG. 11 is a flowchart of an example process, performed by a UE associated with SL-PRS resource cancellation, according to aspects of the disclosure.

### DETAILED DESCRIPTION

Techniques for cancelling sidelink positioning resources, and for responding to such cancellations, are herein presented. Several scenarios are addressed, including full or partial cancellation of SL-PRS resources, cancellation of SL-PRS resources by the base station or by the UE, and cancellation of SL-PRS resources that are controlled by the network or by the UE.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station.” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

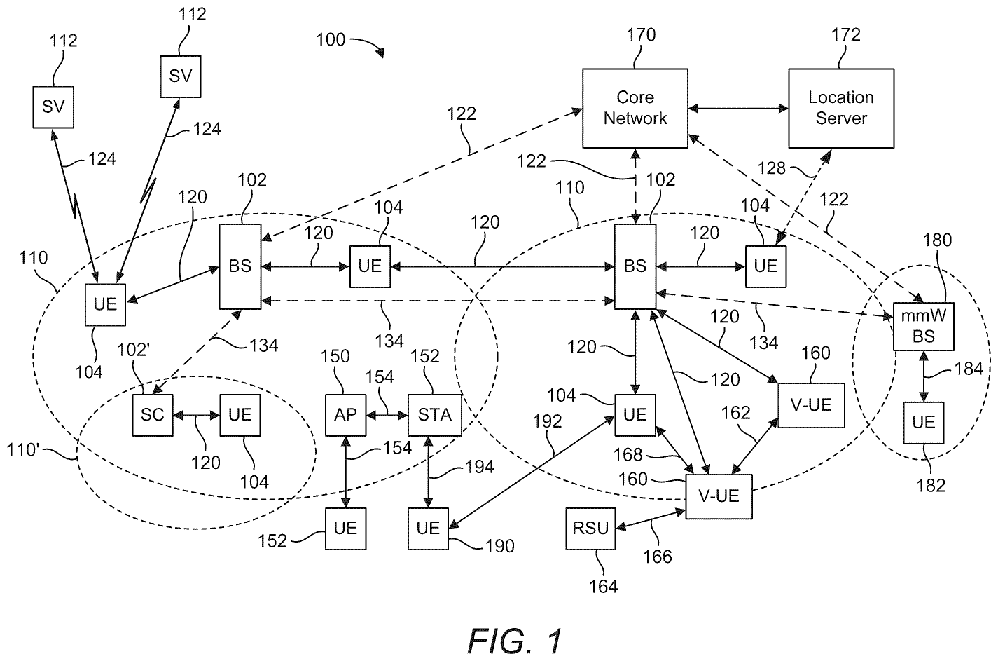

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include cNBs and/or ng-cNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization. RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (cMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell.” “component carrier,” “carrier frequency,” and the like can be used interchangeably.

For example, still referring to FIG. 1, one of the frequencies utilized by the macro cell base stations 102 may be an anchor carrier (or “PCDusell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

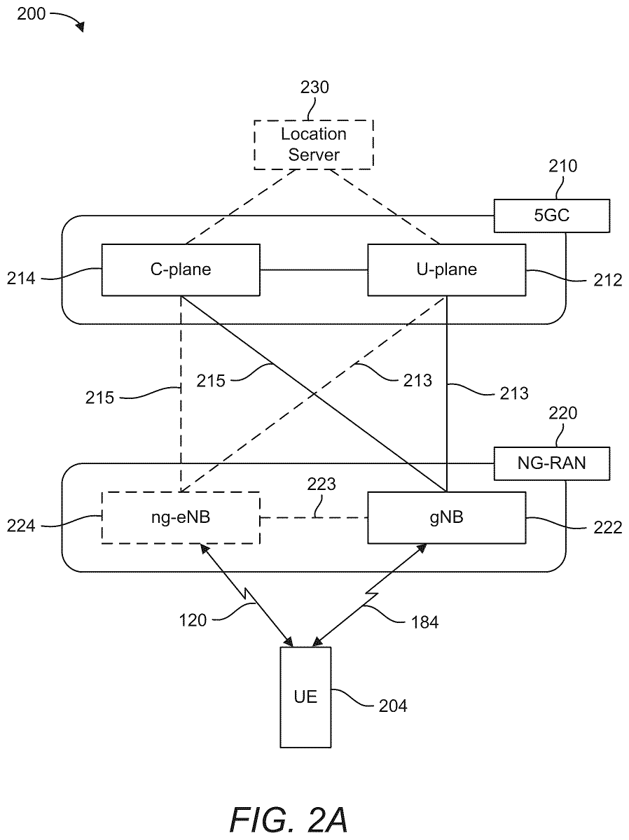

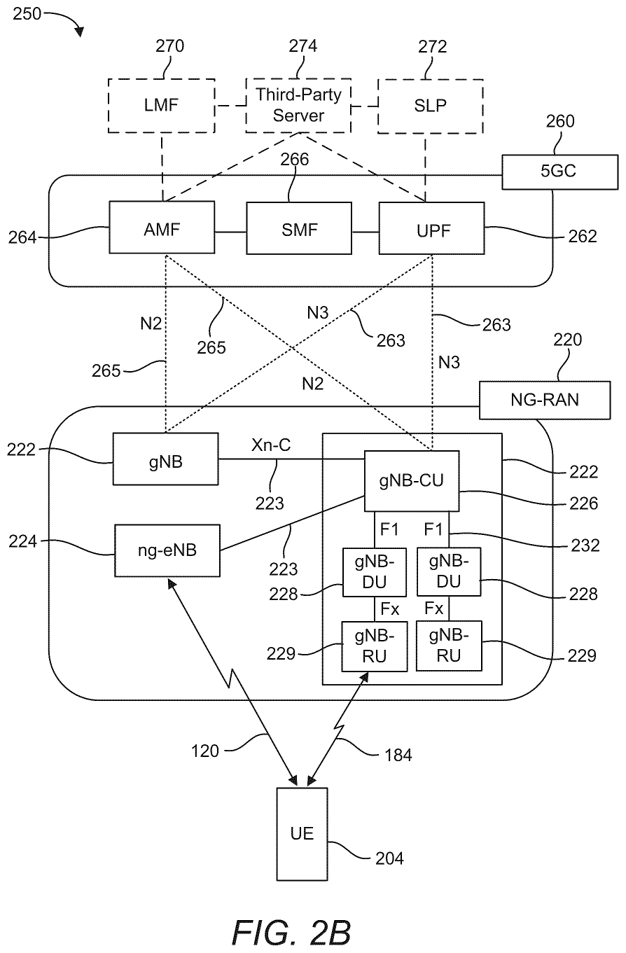

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-cNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and extremal clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

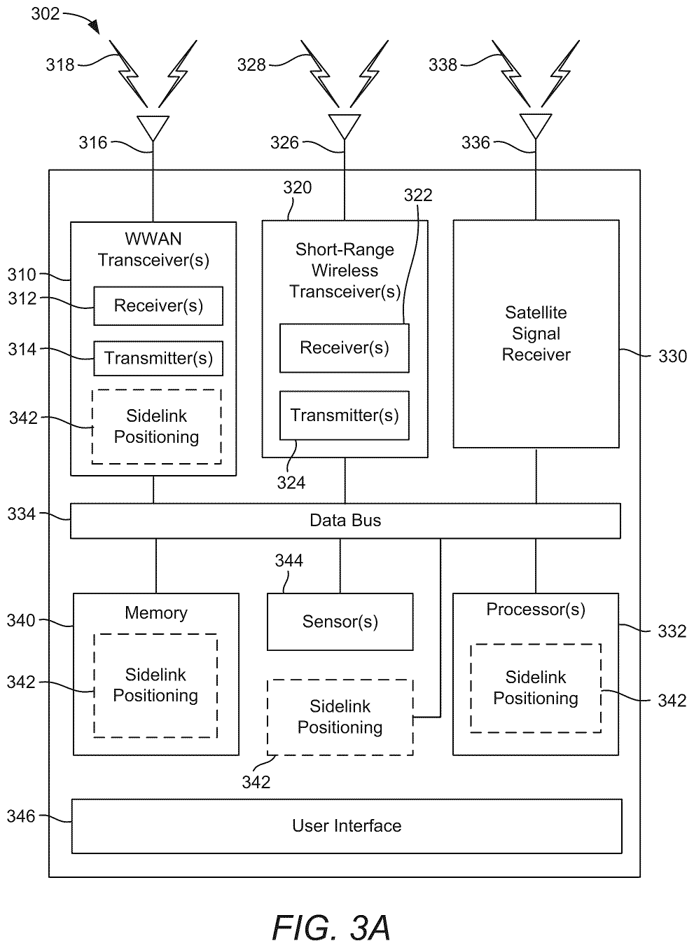

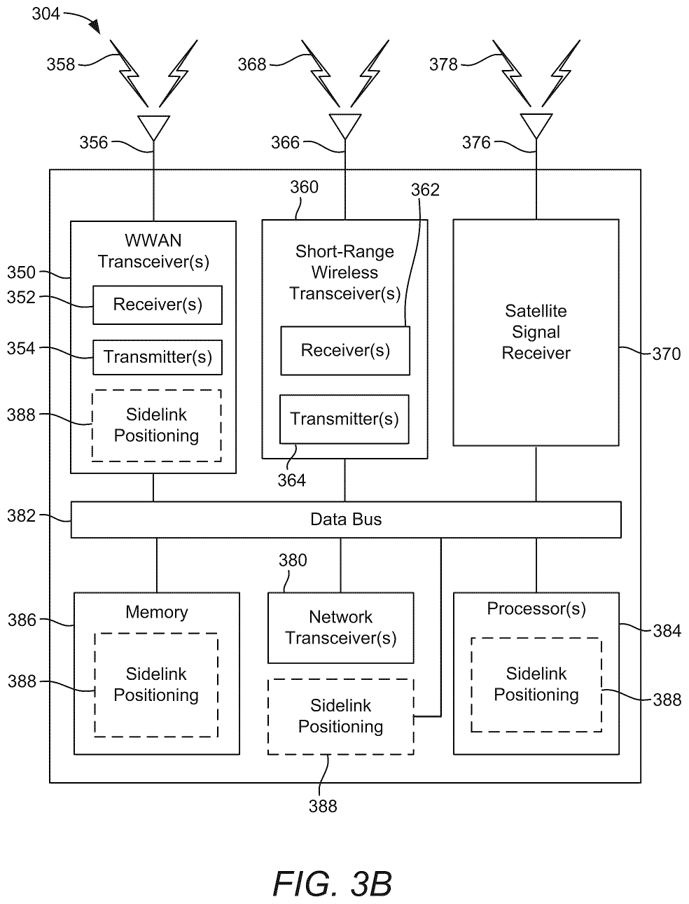

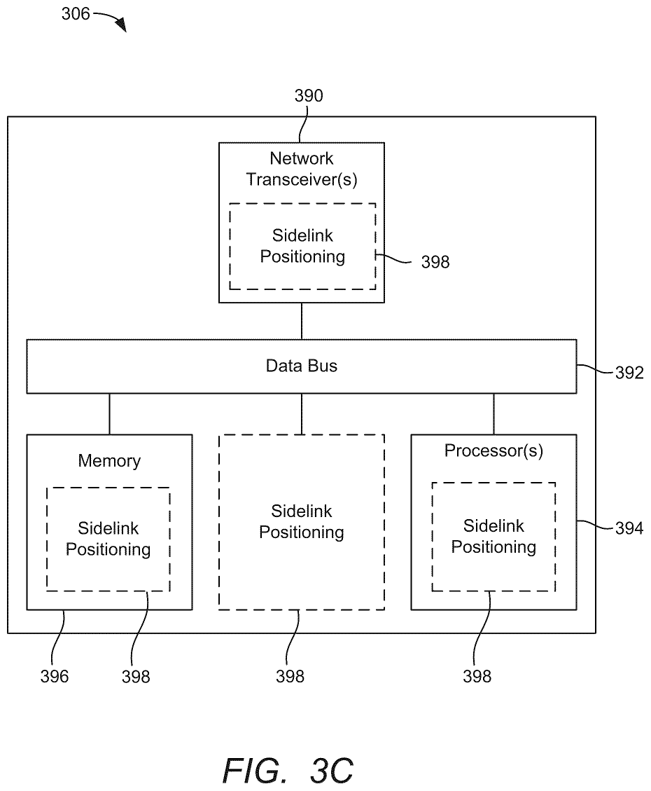

FIG. 3A, FIG. 3B, and FIG. 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR. LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include sidelink positioning module 342, 388, and 398, respectively. The sidelink positioning module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the sidelink positioning module 342, 388, and 398 may be external to the processors 332, 384, and 394 (e.g., part of a modem processing system, integrated with another processing system, etc.). Alternatively, the sidelink positioning module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the sidelink positioning module 342, which may be, for example, part of the one or more WWAN transceivers 310, the memory 340, the one or more processors 332, or any combination thereof, or may be a standalone component. FIG. 3B illustrates possible locations of the sidelink positioning module 388, which may be, for example, part of the one or more WWAN transceivers 350, the memory 386, the one or more processors 384, or any combination thereof, or may be a standalone component. FIG. 3C illustrates possible locations of the sidelink positioning module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK). M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the sidelink positioning module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

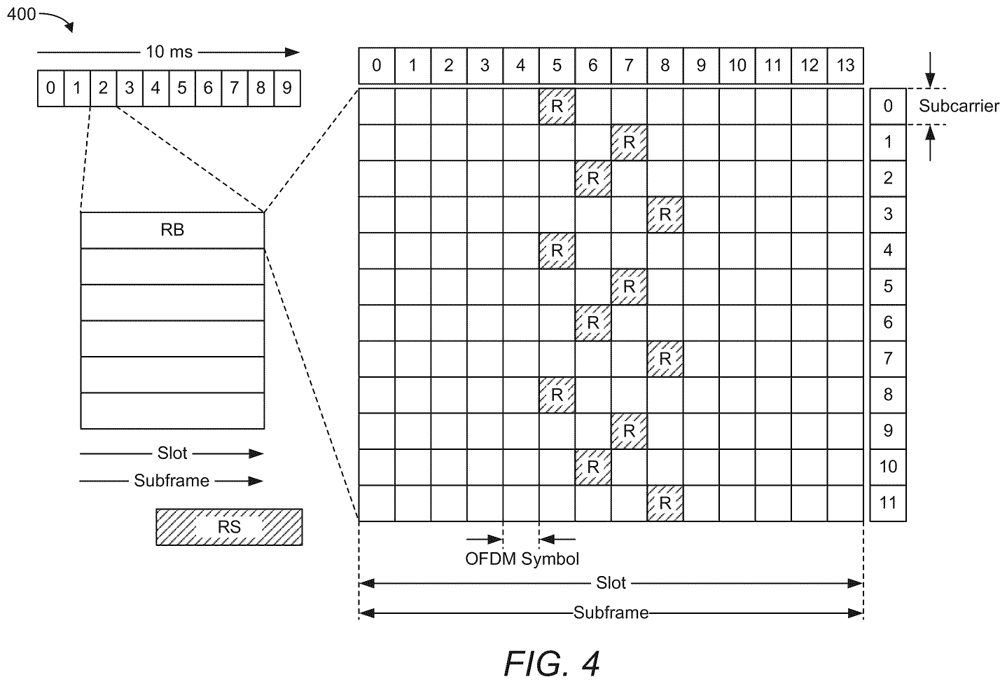

FIG. 4 is a diagram 400 illustrating an example frame structure, according to aspects of the disclosure. Various frame structures may be used to support downlink and uplink transmissions between network nodes (e.g., base stations and UEs). The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (p=0), 30 kHz (p=1), 60 kHz (p=2), 120 kHz (p=3), and 240 kHz (p=4) or greater may be available. In each subcarrier spacing, there are 14 symbols per slot. For 15 kHz SCS (p=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (p=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (p=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (p=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (p=4), there arm 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

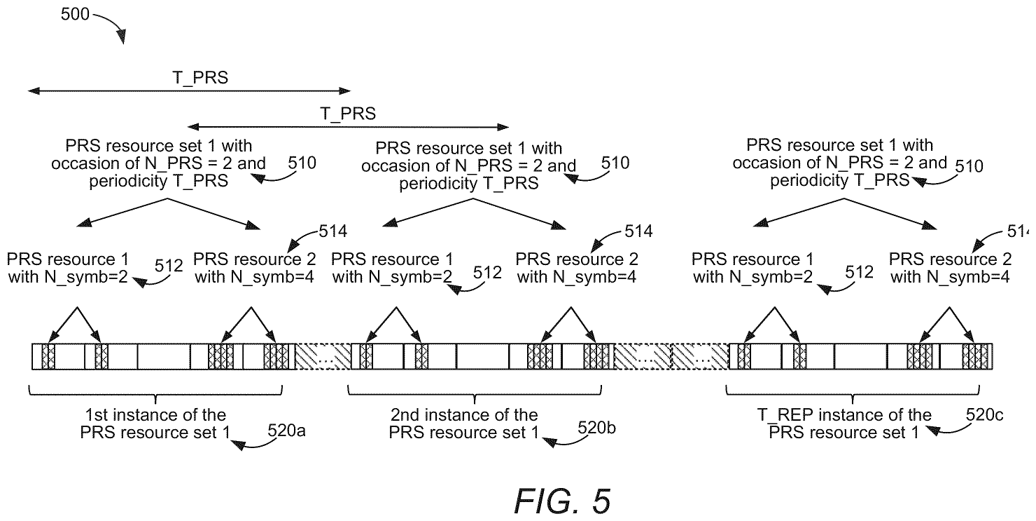

FIG. 5 is a diagram of an example PRS configuration 500 for the PRS transmissions of a given base station, according to aspects of the disclosure. In FIG. 5, time is represented horizontally, increasing from left to right. Each long rectangle represents a slot and each short (shaded) rectangle represents an OFDM symbol. In the example of FIG. 5, a PRS resource set 510 (labeled “PRS resource set 1”) includes two PRS resources, a first PRS resource 512 (labeled “PRS resource 1”) and a second PRS resource 514 (labeled “PRS resource 2”). The base station transmits PRS on the PRS resources 512 and 514 of the PRS resource set 510.

The PRS resource set 510 has an occasion length (N_PRS) of two slots and a periodicity (T_PRS) of, for example, 160 slots or 160 milliseconds (ms)(for 15 kHz subcarrier spacing). As such, both the PRS resources 512 and 514 are two consecutive slots in length and repeat every T_PRS slots, starting from the slot in which the first symbol of the respective PRS resource occurs. In the example of FIG. 5, the PRS resource 512 has a symbol length (N_symb) of two symbols, and the PRS resource 514 has a symbol length (N_symb) of four symbols. The PRS resource 512 and the PRS resource 514 may be transmitted on separate beams of the same base station.

Each instance of the PRS resource set 510, illustrated as instances 520a, 520b, and 520c, includes an occasion of length ‘2’ (i.e., N_PRS=2) for each PRS resource 512, 514 of the PRS resource set. The PRS resources 512 and 514 are repeated every T_PRS slots up to the muting sequence periodicity T_REP. As such, a bitmap of length T_REP would be needed to indicate which occasions of instances 520a, 520b, and 520c of PRS resource set 510 are muted (i.e., not transmitted).

In an aspect, there may be additional constraints on the PRS configuration 500. For example, for all PRS resources (e.g., PRS resources 512, 514) of a PRS resource set (e.g., PRS resource set 510), the base station can configure the following parameters to be the same: (a) the occasion length (N_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

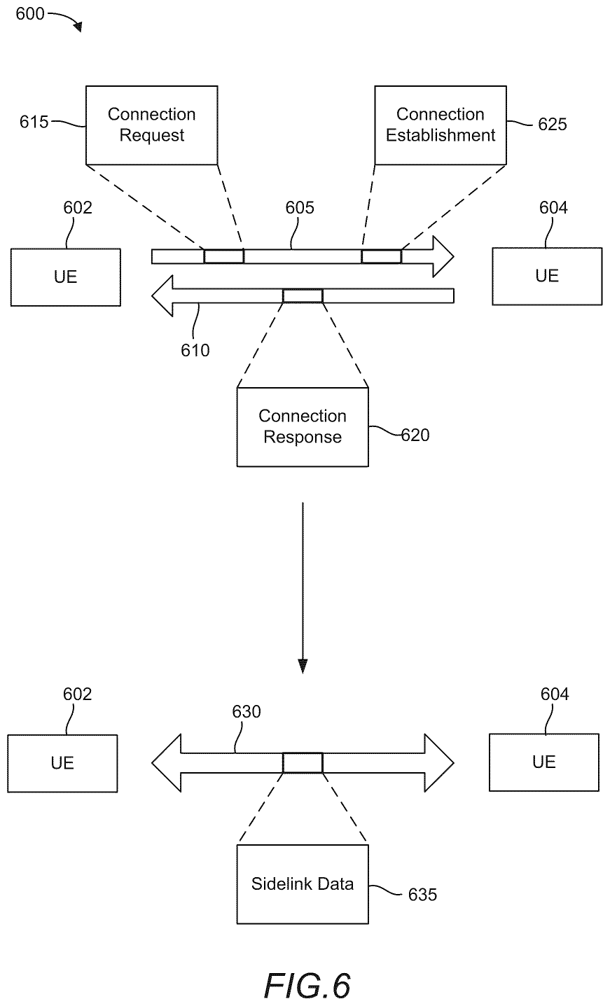

FIG. 6 illustrates an example of a wireless communications system 600 that supports wireless unicast sidelink establishment, according to aspects of the disclosure. In some examples, wireless communications system 600 may implement aspects of wireless communications systems 100, 200, and 250. Wireless communications system 600 may include a first UE 602 and a second UE 604, which may be examples of any of the UEs described herein. As specific examples, UEs 602 and 604 may correspond to V-UEs 160 in FIG. 1.

In the example of FIG. 6, the UE 602 may attempt to establish a unicast connection over a sidelink with the UE 604, which may be a V2X sidelink between the UE 602 and UE 604. As specific examples, the established sidelink connection may correspond to sidelinks 162 and/or 168 in FIG. 1. The sidelink connection may be established in an omni-directional frequency range (e.g., FR1) and/or a mmW frequency range (e.g., FR2). In some cases, the UE 602 may be referred to as an initiating UE that initiates the sidelink connection procedure, and the UE 604 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 602 and UE 604. For example, a transmission and reception capability matching may be negotiated between the UE 602 and UE 604. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 602 and UE 604. Additionally, a security association may be established between UE 602 and UE 604 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally. IP configurations (e.g., IP versions, addresses, etc.) may be negotiated for the unicast connection between UE 602 and UE 604.

In some cases. UE 604 may create a service announcement (e.g., a service capability message) to transmit over a cellular network (e.g., cV2X) to assist the sidelink connection establishment. Conventionally, UE 602 may identify and locate candidates for sidelink communications based on a basic service message (BSM) broadcasted unencrypted by nearby UEs (e.g., UE 604). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 602 is able to detect the BSM(s). Accordingly, the service announcement transmitted by UE 604 and other nearby UEs (e.g., a discovery signal) may be an upper layer signal and broadcasted (e.g., in an NR sidelink broadcast). In some cases, the UE 604 may include one or more parameters for itself in the service announcement, including connection parameters and/or capabilities it possesses. The UE 602 may then monitor for and receive the broadcasted service announcement to identify potential UEs for corresponding sidelink connections. In some cases, the UE 602 may identify the potential UEs based on the capabilities each UE indicates in their respective service announcements.

The service announcement may include information to assist the UE 602 (e.g., or any initiating UE) to identify the UE transmitting the service announcement (UE 604 in the example of FIG. 6). For example, the service announcement may include channel information where direct communication requests may be sent. In some cases, the channel information may be RAT-specific (e.g., specific to LTE or NR) and may include a resource pool within which UE 602 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 602 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential sidelink connection target (UE 604 in the example of FIG. 6), the initiating UE (UE 602 in the example of FIG. 6) may transmit a connection request 615 to the identified target UE 604. In some cases, the connection request 615 may be a first RRC message transmitted by the UE 602 to request a unicast connection with the UE 604 (e.g., an “RRCSetupRequest” message). For example, the unicast connection may utilize the PC5 interface for the sidelink, and the connection request 615 may be an RRC connection setup request message. Additionally, the UE 602 may use a sidelink signaling radio bearer 605 to transport the connection request 615.

After receiving the connection request 615, the UE 604 may determine whether to accept or reject the connection request 615. The UE 604 may base this determination on a transmission/reception capability, an ability to accommodate the unicast connection over the sidelink, a particular service indicated for the unicast connection, the contents to be transmitted over the unicast connection, or a combination thereof. For example, if the UE 602 wants to use a first RAT to transmit or receive data, but the UE 604 does not support the first RAT, then the UE 604 may reject the connection request 615. Additionally or alternatively, the UE 604 may reject the connection request 615 based on being unable to accommodate the unicast connection over the sidelink due to limited radio resources, a scheduling issue, etc. Accordingly, the UE 604 may transmit an indication of whether the request is accepted or rejected in a connection response 620. Similar to the UE 602 and the connection request 615, the UE 604 may use a sidelink signaling radio bearer 610 to transport the connection response 620. Additionally, the connection response 620 may be a second RRC message transmitted by the UE 604 in response to the connection request 615 (e.g., an “RRCResponse” message).

In some cases, sidelink signaling radio bearers 605 and 610 may be the same sidelink signaling radio bearer or may be separate sidelink signaling radio bearers. Accordingly, a radio link control (RLC) layer acknowledged mode (AM) may be used for sidelink signaling radio bearers 605 and 610. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 620 indicates that the UE 604 accepted the connection request 615, the UE 602 may then transmit a connection establishment 625 message on the sidelink signaling radio bearer 605 to indicate that the unicast connection setup is complete. In some cases, the connection establishment 625 may be a third RRC message (e.g., an “RRCSetupComplete” message). Each of the connection request 615, the connection response 620, and the connection establishment 625 may use a basic capability when being transported from one UE to the other UE to enable each UE to be able to receive and decode the corresponding transmission (e.g., the RRC messages).

Additionally, identifiers may be used for each of the connection request 615, the connection response 620, and the connection establishment 625. For example, the identifiers may indicate which UE 602/604 is transmitting which message and/or for which UE 602/604 the message is intended. For physical (PHY) layer channels, the RRC signaling and any subsequent data transmissions may use the same identifier (e.g., Layer 2 IDs) However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 615 and/or the connection response 620 for UE 602 and/or UE 604, respectively, to enable negotiation of corresponding AS layer parameters for the unicast connection. For example, the UE 602 and/or UE 604 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 602 and/or UE 604 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 602 and/or UE 604 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 602 and/or UE 604 may include PHY layer parameters when establishing the unicast connection to set a PHY layer context for the unicast connection. For example, the PHY layer context may indicate a transmission format (unless transmission profiles are included for each UE 602/604) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 625 message is transmitted). Before a security association (e.g., security context) is established between the UE 602 and UE 604, the sidelink signaling radio bearers 605 and 610 may not be protected. After a security association is established, the sidelink signaling radio bearers 605 and 610 may be protected. Accordingly, the security context may enable secure data transmissions over the unicast connection and the sidelink signaling radio bearers 605 and 610. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 604 may base its decision on whether to accept or reject the connection request 615 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 602 and UE 604 may communicate using the unicast connection over a sidelink 630, where sidelink data 635 is transmitted between the two UEs 602 and 604. The sidelink 630 may correspond to sidelinks 162 and/or 168 in FIG. 1. In some cases, the sidelink data 635 may include RRC messages transmitted between the two UEs 602 and 604. To maintain this unicast connection on sidelink 630, UE 602 and/or UE 604 may transmit a keep alive message (e.g., “RRCLinkAlive” message, a fourth RRC message, etc.). In some cases, the keep alive message may be triggered periodically or on-demand (e.g., event-triggered). Accordingly, the triggering and transmission of the keep alive message may be invoked by UE 602 or by both UE 602 and UE 604. Additionally or alternatively, a MAC control element (CE) (e.g., defined over sidelink 630) may be used to monitor the status of the unicast connection on sidelink 630 and maintain the connection. When the unicast connection is no longer needed (e.g., UE 602 travels far enough away from UE 604), either UE 602 and/or UE 604 may start a release procedure to drop the unicast connection over sidelink 630. Accordingly, subsequent RRC messages may not be transmitted between UE 602 and UE 604 on the unicast connection.

NR is capable of supporting various sidelink ranging and positioning techniques. Sidelink-based ranging enables the determination of the relative distance(s) between UEs and optionally their absolute position(s), where the absolute position of at least one involved UE is known. This technique is valuable in situations where global navigation satellite system (GNSS) positioning is degraded or unavailable (e.g., tunnels, urban canyons, etc.) and can also enhance range and positioning accuracy when GNSS is available. Sidelink-based ranging can be accomplished using a three-way handshake for session establishment, followed by the exchange of positioning reference signals (PRS), and concluded by messaging to exchange measurements based on PRS transmission and receipt from peer UEs.

Sidelink ranging is based on calculating an inter-UE round-trip-time (RTT) measurement, as determined from the transmit and receive times of PRS (a wideband positioning signal defined in LTE and NR). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute position. UE participation, PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

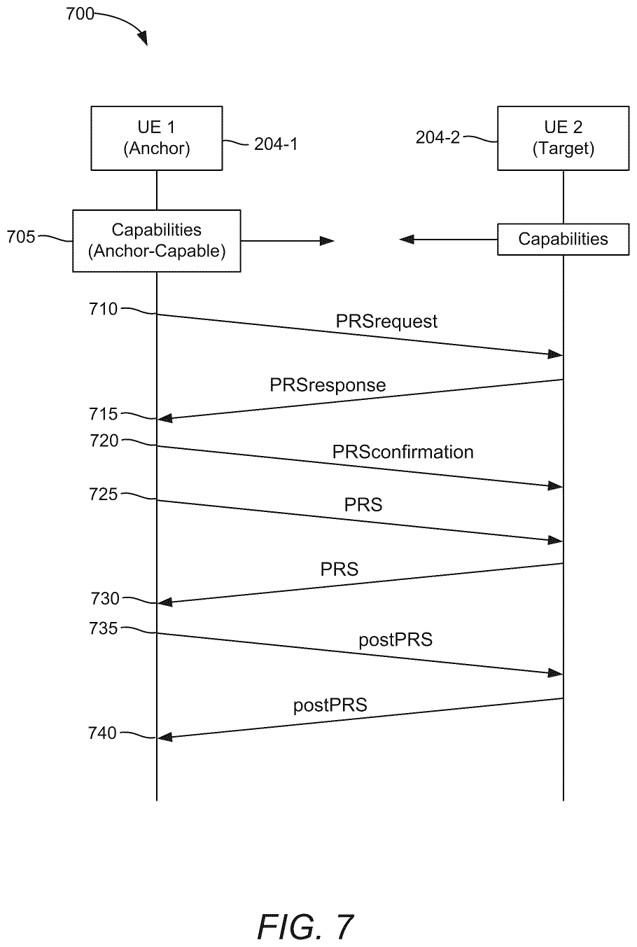

FIG. 7 illustrates an example sidelink ranging and positioning procedure 700, according to aspects of the disclosure. The sidelink ranging and positioning procedure 700 may also be referred to as a sidelink RTT positioning procedure. Sidelink ranging is based on calculating an inter-UE RTT measurement, as determined from the transmit and receive times of PRS (a wideband reference signal defined in LTE and NR for positioning). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute location. UE participation. PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

The sidelink ranging and positioning procedure 700 (or session) begins with the broadcast of capability information by the involved peer UEs at stage 705. As shown in FIG. 7, one of the peer UEs, UE 204-1 (e.g., any of the sidelink-capable UEs described herein), is capable of being an anchor UE for the sidelink ranging and positioning procedure 700, meaning it has a known location. As such, the anchor UE 204-1 includes an indication in its capability message(s) that it is capable of being an anchor UE for the sidelink ranging and positioning procedure 700. The capability message(s) may also include the location of the anchor UE 204-1, or this may be provided later. The other UE, UE 204-2 (e.g., any other of the sidelink-capable UEs described herein), is a target UE, meaning it has an unknown or inaccurate location and is attempting to be located. Based on the capability information received from the anchor UE 204-1, indicating that the anchor UE 204-1 is an anchor UE, the target UE 204-2 knows that it will be able to determine its location based on performing the sidelink ranging and positioning procedure 700 with the anchor UE 204-1.

After the initial capability exchange, the involved UEs 204 perform a three-way messaging handshake. At stage 710, the anchor UE 204-1 transmits a PRS request (labeled “PRSrequest”) to the target UE 204-2. At stage 715, the target UE 204-2 transmits a PRS response (labeled “PRSresponse”) to the anchor UE 204-1. At stage 720, the anchor UE 204-1 transmits a PRS confirmation to the target UE 204-2. At this point, the three-way messaging handshake is complete. Note that although FIG. 7 illustrates the anchor UE 204-1 initiating the three-way message handshake, it may instead be initiated by the target UE 204-2.

At stages 725 and 730, the involved peer UEs 204 transmit PRS to each other. The resources on which the PRS are transmitted may be configured/allocated by the network (e.g., one of the UE's 204 serving base station) or negotiated by the UEs 204 during the three-way messaging handshake. The anchor UE 204-1 measures the transmission-to-reception (Tx-Rx) time difference between the transmission time of PRS at stage 725 and the reception time of PRS at stage 730. The target UE 204-2 measures the reception-to-transmission (Rx-Tx) time difference between the reception time of PRS at stage 725 and the transmission time of PRS at stage 730. Note that although FIG. 7 illustrates the anchor UE 204-1 transmitting PRS first, the target UE 204-2 may instead transmit PRS first.

At stages 735 and 740, the peer UEs 204 exchange their respective time difference measurements in post PRS messages (labeled “postPRS”). If the anchor UE 204-1 has not yet provided its location to the target UE 204-2, it does so at this point. Each UE 204 is then able to determine the RTT between each UE 204 based on the Tx-Rx and Rx-Tx time difference measurements (specifically, the difference between the Tx-Rx and Rx-Tx time difference measurements). Based on the RTT measurement and the speed of light, each UE 204 can then estimate the distance (or range) between the two UEs 204 (specifically, half the RTT measurement multiplied by the speed of light). Since the target UE 204-2 also has the absolute location (e.g., geographic coordinates) of the anchor UE 204-1, the target UE 204-2 can use that location and the distance to the anchor UE 204-1 to determine its own absolute location.

Note that while FIG. 7 illustrates two UEs 204, a UE may perform, or attempt to perform, the sidelink ranging and positioning procedure 700 with multiple UEs.

There are currently two modes for sidelink positioning: SL Mode 1 is network-assisted positioning, and SL Mode 2 is autonomous positioning, e.g., that can be performed in the absence of a gNB or other base station. Sidelink data traffic is generally reservation-based, but there may be periodic or semi-periodic resources that may be configured. Due to high-priority traffic on the Uu link, a serving cell may sometimes indicate to the UE cancel some SL resources and use them instead for the Uu link, which may be alternatively referred to herein as “cancelling”, “reallocating”, “reusing”, or “overwriting” an SL resource.

How this reallocation from SL to Uu affects data communications has been studied, but how such reallocation affects sidelink positioning has not been considered. For example, current standards do not mention, much less consider, the impact that cancellation of SL resources allocated for sidelink positioning, such as sidelink positioning reference signals (SL-PRSs), has on SL positioning, nor do they provide any guidelines regarding how cancellation of SL-PRS resources in particular should be handled.

Moreover, since SL positioning sessions involve multiple UEs, cancellation of SL-PRS resources may have an impact on not only the UE that received the cancellation instruction but also on the other UE involved in the SL positioning session, which may or may not have been notified of the cancellation. Thus, additional issues that need to be addressed include who is to notify the other UE involved in the SL positioning of the cancellation of SL-PRS resources, and also how such notifications should be made.

Accordingly, techniques for cancelling SL-PRS resources, and for responding to such cancellations, are herein presented. Several scenarios are addressed, including full and partial cancellation of SL-PRS resources, cancellation of SL-PRS resources by the base station or by the UE, and cancellation of SL-PRS resources while in SLMode1 and while in SLMode2.

SL-PRS resources are periodic, semi-periodic, or aperiodic (e.g., on-demand) resources configured by a gNB or other base station, or by an LMF or other location server. In SL Mode 1, the network controls the use of those SL-PRS resources. For example, in some aspects, the base station transmits a sidelink cancellation indication (SLCI) to a UE to overwrite a particular set of one or more SL-PRS resources. For example, in some aspects, only one SL-PRS instance is cancelled, e.g., where the high priority traffic is occasional and bursty. In other aspects, the network determines to fully cancel the SL-PRS.

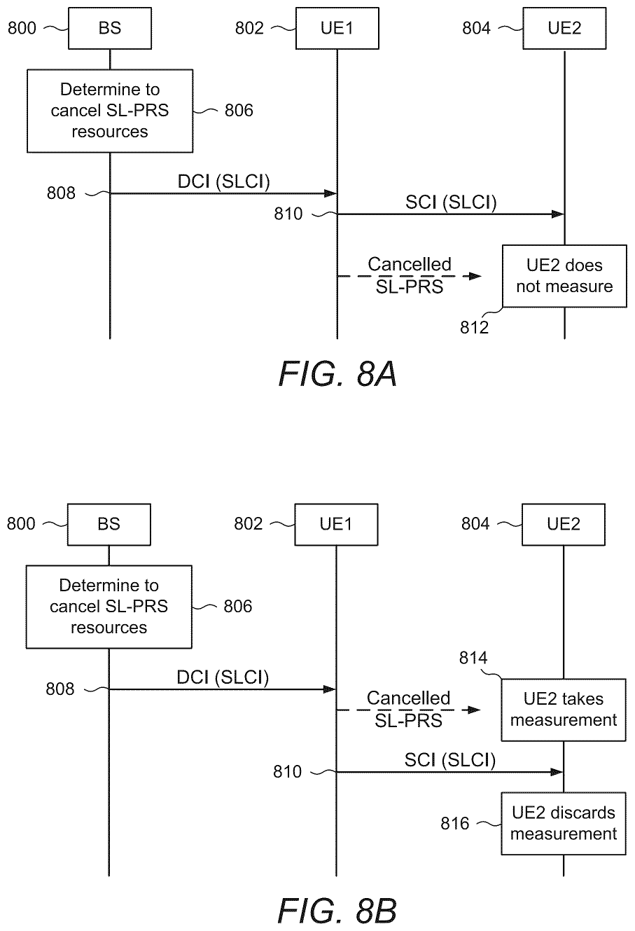

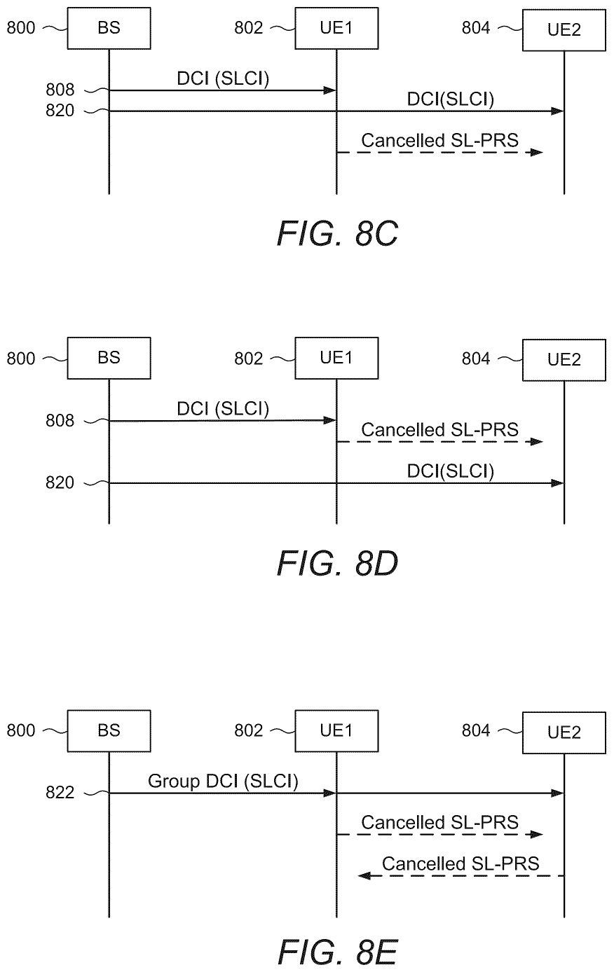

FIG. 8A through FIG. 8E are signal and event diagrams illustrating examples of SL-PRS resource cancellation in SL Mode 1, according to aspects of the disclosure. FIGS. 8A-8E illustrate a network having a base station 800 (e.g., a gNB), and two UEs. UE1 802 and UE2 804, that participate together in a sidelink positioning session.

As shown in FIG. 8A, a base station 800 determines to cancel SL-PRS resources (block 806), and sends downlink control information (DCI) that contains an SLCI to indicate which SL-PRS resources are to be cancelled (message 808). In some aspects, new DCI fields are defined for this purpose, or existing DCI fields are remapped for this purpose.

As further shown in FIG. 8A, UE1 802 receives the DCI containing the SLCI, and notifies UE2 804 via sidelink control information (SCI) that contains the SLCI (message 810). In some aspects, new SCI fields are defined for this purpose, or existing SCI fields are remapped for this purpose. In the example shown in FIG. 8A, it is noted that the SCI message does not cancel transmission of SL-PRS signals by UE2 804, but only notifies UE2 804 that transmission of SL-PRS signals by UE1 802 are cancelled. (Cancellation of transmission of SL-PRS signals by UE2 804 is described in more detail below.)

Since UE2 804 received the SLCI before time that the SL-PRS would have been transmitted had it not been cancelled, UE2 804 does not measure during those SL-PRS resources (block 812).

FIG. 8B illustrates another possible scenario, in which UE1 802 does not notify UE2 804 until after the time that the SL-PRS was scheduled to be transmitted. As shown in FIG. 8B, the base station 800 determines to cancel SL-PRS resources (block 806), and sends downlink control information (DCI) that contains an SLCI to indicate which SL-PRS resources are to be cancelled (message 808), and UE1 802 notifies UE2 804 via sidelink control information (SCI) that contains the SLCI (message 810), but since the notification message 810 occurred after the time that the SL-PRS was originally scheduled to be transmitted, UE2 804 measures what it expects to be the scheduled SL-PRS (block 814). After UE2 804 receives the SCI with SLCI in message 810, however, UE2 804 discards that measurement (block 816).

It is noted that, in order for the BS 800 to use the time-frequency resources originally allocated for SL-PRS for some other purpose, such as for high-priority Uu traffic, the BS 800 needs to notify UE1 802 about the SL-PRS resource cancellation enough in advance that UE1 802 has enough time to make the necessary changes or reconfigurations. The minimum amount of advance warning that UE1 802 needs is herein referred to as a duration of time T_{A}. The value of T_{A} needed by a particular UE depends upon the processing capability of that UE, which the UE can provide directly to the BS 800 or indirectly to the BS 800, e.g., via an LMF or other location server. Depending on the capability of the UE, the value of TA could range from less than a slot to multiple slots.

FIG. 8C, FIG. 8D, and FIG. 8E are signal and event diagrams illustrating additional examples of SL-PRS resource cancellation in SL Mode 1, according to aspects of the disclosure. In contrast to the aspects illustrated in FIG. 8A and FIG. 8B, in which UE1 802 is responsible for notifying UE2 804 of the SLIC, FIGS. 8C-8E illustrate aspects in which the BS 800 notifies UE2 804 of the SLIC. Note that, for clarity, the step in which the base station 800 determines to cancel SL-PRS resources (block 806), the step in which UE2 804 does not measure the SL-PRS resources (block 812), the step in which UE2 804 takes a measurement of the SL-PRS resources (block 814), and the step in which UE2 804 discards a measurement of an SL-PRS resource that UE2 804 later leans was cancelled (block 816), are all omitted from FIGS. 8C-8E.

As shown in FIG. 8C and FIG. 8D, the BS 800 sends the DCI containing the SLCI to UE1 802 (message 808) and also sends another DCI containing the SLCI to UE2 804 (message 820). In FIG. 8C, the second DCI message 820 is received at UE2 804 before the cancelled SL-PRS, so UE 804 does not take a measurement during those resources. In FIG. 8D, the second DCI message 820 is received at UE2 804 after the cancelled SL-PRS. In this scenario, UE2 804 takes a measurement during the SL-PRS resources but later discards that measurement after it receives the second DCI message 820. FIG. 8C and FIG. 8D again illustrate the point that the transmitting UE (e.g., UE1 802) needs to receive the notification in time to avoid transmitting the SL-PRS, but the receiving UE (e.g., UE2 804) can receive its notification either before or soon after the SL-PRS occasion.

FIG. 8E illustrates an aspect in which the BS 800 transmits a group DCI containing the SLCI (message 822), which is received by both UE1 802 and UE2 804. In this example, the group message operates to notify UE1 802 to cancel the SL-PRS transmission and to notify, UE2 804 to not take a measurement during those SL-PRS resources. FIG. 8E also illustrates the point that the BS 800 may also notify UE2 804 to cancel one of its SL-PRS transmissions, which UE1 802 then knows to ignore, i.e., to not take a measurement during those cancelled SL-PRS resources.

Where sidelink RTI positioning measurements are being taken, the BS 800 will need to cancel transmission from two or more UEs. It is possible that the BS 800 may determine that it needs to cancel some SL-PRS resources after one UE has transmitted its SL-PRS signals but before another UE has transmitted its SL-PRS signals. For example, if the BS 800 determines that it needs to cancel some SL-PRS resources after UE1 802 has transmitted its SL-PRS signals, BS 800 may send the SLCI only to UE2 804—or more specifically the BS 800 may instruct only UE2 804 to cancel its SL-PRS transmission, since UE1 802 has already completed its SL-PRS transmission.

The examples shown in FIG. 8A-8E are illustrative and not limiting. For example, to cancel SL-PRS transmissions from both UE1 802 and UE2 804, the BS 800 could send separate pairs of messages—one to the transmitter, one to the receiver—for each direction, for four messages total. Alternatively, the BS 800 could send just two messages—one to the transmitter, one to the receiver—each message indicating cancellation of both directions, or just one group message indicating the cancellation of both directions. Other implementations are also within the scope of the present disclosure.

In some aspects, the SL-PRS resources that are cancelled can be specific SL-PRS resources, all SL-PRS resources in a resource set for all occasions, all SL-PRS resources in a resource set for one occasion, all SL-PRS resources in a resource set for more than one but less than all occasions, or all SL-PRS resources within a particular time window regardless of the resource set to which they belong. In some aspects, the cancelled SL-PRS resources may be used for UL traffic; in some aspects, the cancelled SL-PRS resources may be used for other, higher priority SL traffic, e.g., SL data rather than SL positioning.

The SL-PRS resource cancellation may be proactive (occurring before the base station has received traffic that needs to preempt the UE's SL-PRS) or reactive (occurring after the base station has received traffic that needs to preempt the UE's SL-PRS), but in both cases, the SL-PRS resource cancellation occurs before the preempted SL-PRS resources.

SL-PRS resources may be fully cancelled (e.g., as described above) or partially cancelled, such as by reducing the SL-PRS bandwidth, reducing the number of SL-PRS symbols used, by reducing the number of repetitions of SL-PRS signals, or a combination thereof. Reduction of SL-PRS bandwidth is good for angle-based positioning methods and may be used for timing-based positioning methods. Reduction of SL-PRS symbols may include cancelling one of the symbols used for automatic gain control (AGC), based on the presumption that channel gain changes relatively slowly over time and thus the previous gain value can be reused.

In some aspects, for both full and partial cancellation, an SL-PRS transmitted by a UE may also be monitored by other transmission/reception points (TRPs) in the area. In some aspects, a serving TRP may notify neighbor TRPs about the cancellation. In some aspects the serving TRP may notify an LMF or other location server about the cancellation.

In SL Mode 2, the network does not control the use of SL-PRS resources. Instead, the UEs may autonomously control that use. For example, in some aspects, one UE involved in a sidelink communication or positioning session with another UE may transmit a sidelink cancellation indication (SLCI) to overwrite a particular set of one or more SL-PRS resources.

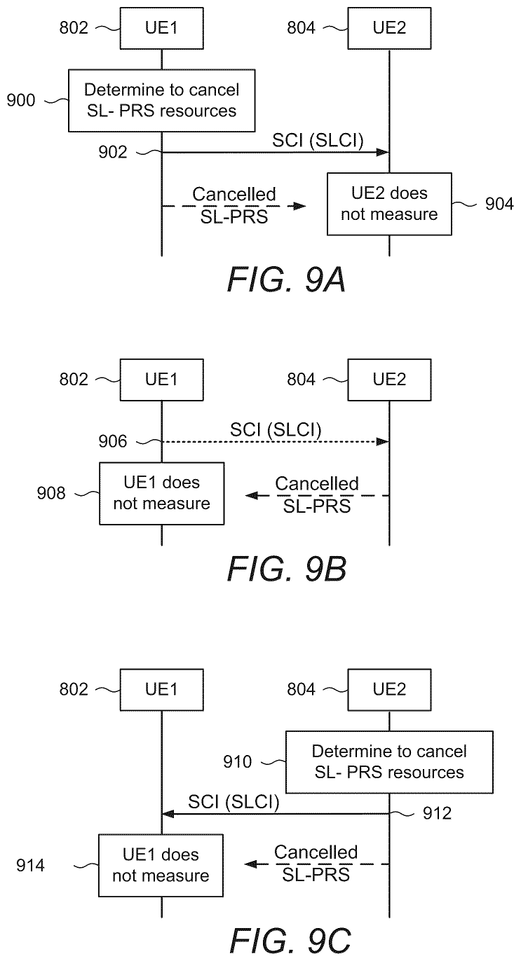

FIG. 9A through FIG. 9C are signal and event diagrams illustrating examples of SL-PRS resource cancellation in SL Mode 2, according to aspects of the disclosure. FIGS. 9A-9E illustrate a network having two UEs, UE1 802 and UE2 804, that participate together in a sidelink positioning session.

As shown in FIG. 9A, UE1 802 determines that it need to cancel some SL-PRS resources (block 900), and sends to UE2 804 sidelink control information (SCI) that contains an SLCI to indicate which SL-PRS resources are to be cancelled (message 902). In some aspects, new SCI fields are defined for this purpose, or existing SCI fields are remapped for this purpose. In the example in FIG. 9A, the SL-PRS resources to be cancelled are those used by UE1 802 to transmit SL-PRS signals. UE2 804 receives the SLCI and as a result does not measure the cancelled SL-PRS (block 904).

As shown in FIG. 9B, UE1 802 may optionally send another SCI that contains another SLCI to indicate the cancellation of SL-PRS resources that are used by UE2 804 to transmit SL-PRS signals. (Alternatively, the SLCI in message 902, above, may also indicate the cancellation of SL-PRS resources that are used by UE2 804 to transmit SL-PRS signals.) knowing that UE2 804 will cancel any SL-PRS transmission that would have used the cancelled SL-PRS resources, UE1 802 does not measure during the cancelled SL-PRS resources (block 908).

As shown in FIG. 9C, UE2 804, rather than UE1 802, may determine to cancel its own SL-PRS resources (block 910), and send to UE1 802 an SCI that includes an SLCI that indicates the cancelled SL-PRS resources (message 912). UE1 802 then knows not to take measurements during the cancelled SL-PRS resources (block 914).

In some aspects, an SL-PRS resource may be rescheduled rather than cancelled. Situations in which an SL-PRS resource should be rescheduled rather than cancelled include, but are not limited to, where N SL-PRS instances were configured but only M<N SL-PRS instance were performed, where the cancelled SL-PRS was an on-demand SL-PRS rather than a periodic SL-PRS, or where the cancelled SL-PRS was part of an RTT pair of measurements. In SL Mode 1, the base station (or a UE acting as a coordinator) may determine whether or not an SL-PRS resource should be rescheduled rather than cancelled. In SL Mode 2, the UE that dropped the transmission or the UE that started the RTT protocol session may determine whether or not an SL-PRS resource should be rescheduled rather than cancelled. Rescheduling may be implemented with grants or MAC-CE messages, for example.

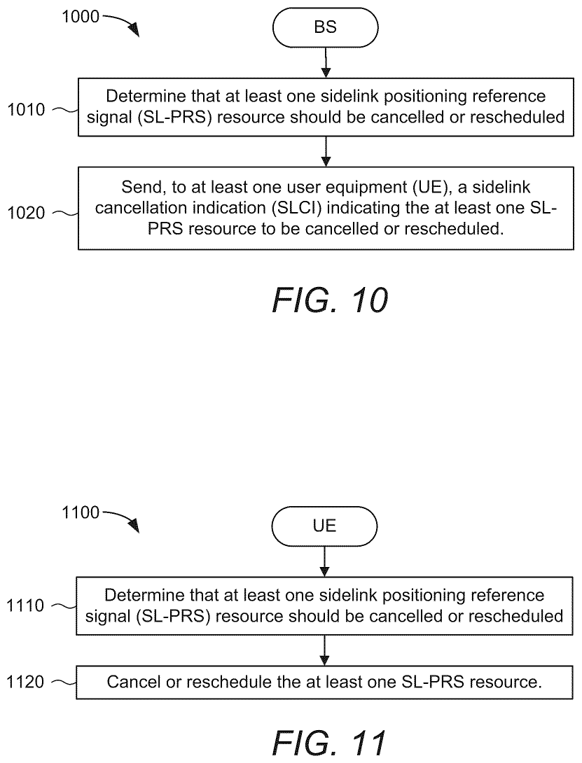

FIG. 10 is a flowchart of an example process 1000 associated with SL-PRS resource cancellation, according to aspects of the disclosure. In some implementations, one or more process blocks of FIG. 10 may be performed by a network entity (NE)(e.g., BS 102, location server 172). In some implementations, one or more process blocks of FIG. 10 may be performed by another device or a group of devices separate from or including the NE. Additionally, or alternatively, one or more process blocks of FIG. 10 may be performed by one or more components of base station 304, such as processor(s) 384, memory 386, WWAN transceiver(s) 350, network transceiver(s) 380, and sidelink positioning module(s) 388, any or all of which may be means for performing the operations of process 1000.

As shown in FIG. 10, process 1000 may include determining that at least one sidelink positioning reference signal (SL-PRS) resource should be cancelled or rescheduled (block 1010). Means for performing the operation of block 1010 may include the processor(s) 384, memory 386, or WWAN transceiver(s) 350 of the base station 304. For example, the processor(s) 384 of the base station 304 may determine that at least one sidelink positioning reference signal (SL-PRS) resource should be cancelled or rescheduled, using information received from a location server via the network transceiver(s) 380 and/or information received from a UE via the WWAN transceiver(s) 350, as well as information stored in memory 386. In some aspects, determining that at least one SL-PRS resource should be cancelled or rescheduled comprises determining that the at least one SL-PRS resource should be used instead for a higher priority uplink, downlink, or sidelink communication. In some aspects, determining that at least one SL-PRS resource should be cancelled or rescheduled comprises determining that the at least one SL-PRS resource should be rescheduled instead of cancelled, based on a determination that fewer than a configured number of SL-PRS instances were performed, that the at least one SL-PRS resource is part of an on-demand SL-PRS, or that the at least one SL-PRS resource is part of a round-trip time (RTT) pair of measurements. In some aspects, the at least one SL-PRS resource to be cancelled or rescheduled comprises a specific SL-PRS resource, one occasion of a specific SL-PRS resource set, all occasions of a specific SL-PRS resource set, or all SL-PRS resources within a defined window of time, regardless of the SL-PRS resource set to which they belong.

As further shown in FIG. 10, process 1000 may include sending, to at least one user equipment (UE), a sidelink cancellation indication (SLCI) indicating the at least one SL-PRS resource to be cancelled or rescheduled (block 1020). Means for performing the operation of block 1020 may include the processor(s) 384, memory 386, or WWAN transceiver(s) 350 of the base station 304. For example, the base station 304 may send, to at least one UE, a sidelink cancellation indication (SLCI) indicating the at least one SL-PRS resource to be cancelled or rescheduled, using the transmitter(s) 354. In some aspects, sending the SLCI comprises sending the SLCI as part of downlink control information (DCI). The SLCI may be sent to the UE that is configured to transmit SL-PRS signals over the at least one SL-PRS resource, to at least one UE that is configured to receive the SL-PRS signals transmitted over the at least one SL-PRS resource, or to all of the above.

Process 1000 may include additional implementations, such as any single implementation or any combination of implementations described below and/or in connection with one or more other processes described elsewhere herein. Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a flowchart of another example process 1100 associated with SL-PRS resource cancellation, according to aspects of the disclosure. In some implementations, one or more process blocks of FIG. 11 may be performed by a user equipment (UE) (e.g., UE 104). In some implementations, one or more process blocks of FIG. 11 may be performed by another device or a group of devices separate from or including the UE. Additionally, or alternatively, one or more process blocks of FIG. 11 may be performed by one or more components of UE 302, such as processor(s) 332, memory 340, WWAN transceiver(s) 310, short-range wireless transceiver(s) 320, satellite signal receiver 330, sensor(s) 344, user interface 346, and sidelink positioning module(s) 342, any or all of which may be means for performing the operations of process 1100.

As shown in FIG. 11, process 1100 may include determining that at least one sidelink positioning reference signal (SL-PRS) resource should be cancelled or rescheduled (block 1110). Means for performing the operation of block 1110 may include the processor(s) 332, memory 340, or WWAN transceiver(s) 310 of the UE 302. For example, in some aspects, determining that at least one SL-PRS resource should be cancelled or rescheduled comprises receiving a SLCI indicating the at least one SL-PRS resource to be cancelled or rescheduled from a network entity, such as a base station or a location server, or from a sidelink peer UE, e.g., using the receiver(s) 312. In some aspects, receiving the SLCI comprises receiving the SLCI from the network entity via downlink control information (DCI) or from the sidelink peer UE via sidelink control information (SCI).

In some aspects, determining that at least one SL-PRS resource should be cancelled or rescheduled comprises determining that the at least one SL-PRS resource should be used instead for a higher priority uplink, downlink, or sidelink communication. In some aspects, the at least one SL-PRS resource to be cancelled or rescheduled comprises a specific SL-PRS resource, one occasion of a specific SL-PRS resource set, all occasions of a specific SL-PRS resource set, or all SL-PRS resources within a defined window of time, regardless of the SL-PRS resource set to which they belong.

As further shown in FIG. 11, process 1100 may include canceling the at least one SL-PRS resource (block 1120). Means for performing the operation of block 1120 may include the processor(s) 332, memory 340, or WWAN transceiver(s) 310 of the UE 302. For example, the processor(s) 332 of the UE 302 may cancel or reschedule the at least one SL-PRS resource. In some aspects, canceling or rescheduling the at least one SL-PRS resource comprises at least one of canceling SL-PRS transmissions within the at least one SL-PRS resource, not performing measurements of SL-PRS transmissions within the at least one SL-PRS resource, or discarding measurements previously made of SL-PRS transmissions within the at least one SL-PRS resource.

In some aspects, process 1100 further includes sending, to at least one sidelink peer UE, a sidelink cancellation indication (SLCI) indicating the at least one SL-PRS resource to be cancelled or rescheduled. In some aspects, sending the SLCI comprises sending the SLCI via sidelink control information (SCI).

Process 1100 may include additional implementations, such as any single implementation or any combination of implementations described below and/or in connection with one or more other processes described elsewhere herein. Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

As will be appreciated, a technical advantage of the method 1000 and method 1100 is that the impact that cancellation of SL-PRS resources has on sidelink positioning methods is considered and mitigated. For example, some of the techniques described herein require that the UE that is scheduled to transmit the SL-PRS receive the cancellation with some minimum amount of lead time prior to the scheduled transmission. Some of the techniques described herein provide a mechanism by which a network entity or sidelink UE can make a determination whether to reschedule, rather than simply cancel, a SL-PRS transmission. Some of the techniques described herein provide a mechanism by which some or all SL-PRS resources within a resource set are cancelled or rescheduled; one, some or all occurrences or repetitions of a resource set are cancelled or rescheduled; or all SL-PRS resources within a defined window of time are cancelled or rescheduled, regardless of which resource set they belong to.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a network entity, the method comprising: determining that at least one sidelink positioning reference signal (SL-PRS) resource should be cancelled or rescheduled; and sending, to at least one user equipment (UE), a sidelink cancellation indication (SLCI) indicating the at least one SL-PRS resource to be cancelled or rescheduled.

Clause 2. The method of clause 1, wherein determining that at least one SL-PRS resource should be cancelled or rescheduled comprises determining that the at least one SL-PRS resource should be used instead for a higher priority uplink, downlink, or sidelink communication.

Clause 3. The method of any of clauses 1 to 2, wherein determining that at least one SL-PRS resource should be cancelled or rescheduled comprises determining that the at least one SL-PRS resource should be rescheduled instead of cancelled, based on a determination that: fewer than a configured number of SL-PRS instances were performed; the at least one SL-PRS resource is part of an on-demand SL-PRS; or the at least one SL-PRS resource is part of a round-trip time (RTT) pair of measurements.

Clause 4. The method of any of clauses 1 to 3, wherein sending the SLCI comprises sending the SLCI as part of downlink control information (DCI).

Clause 5. The method of any of clauses 1 to 4, wherein sending SLCI to the at least one UE comprises sending the SLCI to the UE that is configured to transmit SL-PRS signals over the at least one SL-PRS resource.

Clause 6. The method of clause 5, wherein sending SLCI to the at least one UE further comprises sending the SLCI to a UE that is configured to receive the SL-PRS signals transmitted over the at least one SL-PRS resource.

Clause 7. The method of any of clauses 1 to 6, wherein the network entity comprises a base station or a location server.

Clause 8. A method of wireless communication performed by a first user equipment (UE), the method comprising: determining that at least one sidelink positioning reference signal (SL-PRS) resource should be cancelled or rescheduled; and cancelling or rescheduling the at least one SL-PRS resource.

Clause 9. The method of clause 8, wherein determining that at least one SL-PRS resource should be cancelled or rescheduled comprises receiving, from a network entity or a sidelink peer UE, a sidelink cancellation indication (SLCI) indicating the at least one SL-PRS resource to be cancelled or rescheduled.

Clause 10. The method of clause 9, wherein receiving the SLCI comprises receiving the SLCI via downlink control information (DCI) or sidelink control information (SCI).

Clause 11. The method of any of clauses 8 to 10, wherein determining that at least one SL-PRS resource should be cancelled or rescheduled comprises determining that the at least one SL-PRS resource should be used instead for a higher priority uplink, downlink, or sidelink communication.

Clause 12. The method of any of clauses 8 to 11, wherein determining that at least one SL-PRS resource should be cancelled or rescheduled comprises determining that the at least one SL-PRS resource should be rescheduled instead of cancelled, based on a determination that: fewer than a configured number of SL-PRS instances were performed; the at least one SL-PRS resource is part of an on-demand SL-PRS; or the at least one SL-PRS resource is part of a round-trip time (RTT) pair of measurements.

Clause 13. The method of any of clauses 8 to 12, wherein cancelling or rescheduling the at least one SL-PRS resource comprises at least one of: cancelling SL-PRS transmissions within the at least one SL-PRS resource; not performing measurements of SL-PRS transmissions within the at least one SL-PRS resource; or discarding measurements previously made of SL-PRS transmissions within the at least one SL-PRS resource.

Clause 14. The method of any of clauses 8 to 13, further comprising sending, to at least one sidelink peer UE, a sidelink cancellation indication (SLCI) indicating the at least one SL-PRS resource to be cancelled or rescheduled.

Clause 15. The method of clause 14, wherein sending the SLCI comprises sending the SLCI via sidelink control information (SCI).

Clause 16. A network entity, comprising: a memory; at least one transceiver; and at least one processor communicatively coupled to the memory and the at least one transceiver, the at least one processor configured to: determine that at least one sidelink positioning reference signal (SL-PRS) resource should be cancelled or rescheduled; and send, via the at least one transceiver, to at least one user equipment (UE), a sidelink cancellation indication (SLCI) indicating the at least one SL-PRS resource to be cancelled or rescheduled.

Clause 17. The network entity of clause 16, wherein, to determine that at least one SL-PRS resource should be cancelled or rescheduled, the at least one processor is configured to determine that the at least one SL-PRS resource should be used instead for a higher priority uplink, downlink, or sidelink communication.

Clause 18. The network entity of any of clauses 16 to 17, wherein, to determine that at least one SL-PRS resource should be cancelled or rescheduled, the at least one processor is configured to determine that the at least one SL-PRS resource should be rescheduled instead of cancelled, based on a determination that: fewer than a configured number of SL-PRS instances were performed; the at least one SL-PRS resource is part of an on-demand SL-PRS; or the at least one SL-PRS resource is part of a round-trip time (RTT) pair of measurements.

Clause 19. The network entity of any of clauses 16 to 18, wherein, to send the SLCI, the at least one processor is configured to send the SLCI as part of downlink control information (DCI).

Clause 20. The network entity of any of clauses 16 to 19, wherein, to send SLCI to the at least one UE, the at least one processor is configured to send the SLCI to the UE that is configured to transmit SL-PRS signals over the at least one SL-PRS resource.

Clause 21. The network entity of clause 20, wherein, to send SLCI to the at least one UE, the at least one processor is configured to send the SLCI to a UE that is configured to receive the SL-PRS signals transmitted over the at least one SL-PRS resource.

Clause 22. The network entity of any of clauses 16 to 21, wherein the network entity comprises a base station or a location server.

Clause 23. A user equipment (UE), comprising: a memory; at least one transceiver; and at least one processor communicatively coupled to the memory and the at least one transceiver, the at least one processor configured to: determine that at least one sidelink positioning reference signal (SL-PRS) resource should be cancelled or rescheduled; and cancel or reschedule the at least one SL-PRS resource.

Clause 24. The UE of clause 23, wherein, to determine that at least one SL-PRS resource should be cancelled or rescheduled, the at least one processor is configured to receive, from a network entity or a sidelink peer UE, a sidelink cancellation indication (SLCI) indicating the at least one SL-PRS resource to be cancelled or rescheduled.

Clause 25. The UE of clause 24, wherein, to receive the SLCI, the at least one processor is configured to receive the SLCI via downlink control information (DCI) or sidelink control information (SCI).

Clause 26. The UE of any of clauses 23 to 25, wherein, to determine that at least one SL-PRS resource should be cancelled or rescheduled, the at least one processor is configured to determine that the at least one SL-PRS resource should be used instead for a higher priority uplink, downlink, or sidelink communication.

Clause 27. The UE of any of clauses 23 to 26, wherein, to determine that at least one SL-PRS resource should be cancelled or rescheduled, the at least one processor is configured to determine that the at least one SL-PRS resource should be rescheduled instead of cancelled, based on a determination that: fewer than a configured number of SL-PRS instances were performed: the at least one SL-PRS resource is part of an on-demand SL-PRS; or the at least one SL-PRS resource is part of a round-trip time (RTT) pair of measurements.

Clause 28. The UE of any of clauses 23 to 27, wherein, to cancel or reschedule the at least one SL-PRS resource, the at least one processor is configured to: cancel SL-PRS transmissions within the at least one SL-PRS resource; not perform measurements of SL-PRS transmissions within the at least one SL-PRS resource: or discard measurements previously made of SL-PRS transmissions within the at least one SL-PRS resource.

Clause 29. The UE of any of clauses 23 to 28, wherein the at least one processor is further configured to send, via the at least one transceiver, to at least one sidelink peer UE, a sidelink cancellation indication (SLCI) indicating the at least one SL-PRS resource to be cancelled or rescheduled.

Clause 30. The UE of clause 29, wherein, to send the SLCI, the at least one processor is configured to send the SLCI via sidelink control information (SCI).

Clause 31. An apparatus comprising a memory, a transceiver, and a processor communicatively coupled to the memory and the transceiver, the memory, the transceiver, and the processor configured to perform a method according to any of clauses 1 to 15.

Clause 32. An apparatus comprising means for performing a method according to any of clauses 1 to 15.

Clause 33. A non-transitory computer-readable medium storing computer-executable instructions, the computer-executable comprising at least one instruction for causing a computer or processor to perform a method according to any of clauses 1 to 15.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a network entity, the method comprising:
determining that at least one sidelink positioning reference signal (SL-PRS) resource should be cancelled or rescheduled; and
sending, to at least one user equipment (UE), a sidelink cancellation indication (SLCI) indicating the at least one SL-PRS resource to be cancelled or rescheduled.

2. The method of claim 1, wherein determining that at least one SL-PRS resource should be cancelled or rescheduled comprises determining that the at least one SL-PRS resource should be used instead for a higher priority uplink, downlink, or sidelink communication.

3. The method of claim 1, wherein determining that at least one SL-PRS resource should be cancelled or rescheduled comprises determining that the at least one SL-PRS resource should be rescheduled instead of cancelled, based on a determination that:
fewer than a configured number of SL-PRS instances were performed;
the at least one SL-PRS resource is part of an on-demand SL-PRS; or
the at least one SL-PRS resource is part of a round-trip time (RTT) pair of measurements.

4. The method of claim 1, wherein sending the SLCI comprises sending the SLCI as part of downlink control information (DCI).

5. The method of claim 1, wherein sending SLCI to the at least one UE comprises sending the SLCI to the UE that is configured to transmit SL-PRS signals over the at least one SL-PRS resource.

6. The method of claim 5, wherein sending SLCI to the at least one UE further comprises sending the SLCI to a UE that is configured to receive the SL-PRS signals transmitted over the at least one SL-PRS resource.

7. The method of claim 1, wherein the at least one SL-PRS resource to be cancelled or rescheduled comprises:
a specific SL-PRS resource;
one occasion of a specific SL-PRS resource set;
all occasions of a specific SL-PRS resource set; or
all SL-PRS resources within a defined window of time.

8. A method of wireless communication performed by a first user equipment (UE), the method comprising:
determining that at least one sidelink positioning reference signal (SL-PRS) resource should be cancelled or rescheduled; and
cancelling or rescheduling the at least one SL-PRS resource.

9. The method of claim 8, wherein determining that at least one SL-PRS resource should be cancelled or rescheduled comprises receiving, from a network entity or a sidelink peer UE, a sidelink cancellation indication (SLCI) indicating the at least one SL-PRS resource to be cancelled or rescheduled.

10. The method of claim 9, wherein receiving the SLCI comprises receiving the SLCI via downlink control information (DCI) or sidelink control information (SCI).

11. The method of claim 8, wherein determining that at least one SL-PRS resource should be cancelled or rescheduled comprises determining that the at least one SL-PRS resource should be used instead for a higher priority uplink, downlink, or sidelink communication.

12. The method of claim 8, wherein determining that at least one SL-PRS resource should be cancelled or rescheduled comprises determining that the at least one SL-PRS resource should be rescheduled instead of cancelled, based on a determination that:
fewer than a configured number of SL-PRS instances were performed;
the at least one SL-PRS resource is part of an on-demand SL-PRS; or
the at least one SL-PRS resource is part of a round-trip time (RT) pair of measurements.

13. The method of claim 8, wherein cancelling or rescheduling the at least one SL-PRS resource comprises at least one of:
cancelling SL-PRS transmissions within the at least one SL-PRS resource;
not performing measurements of SL-PRS transmissions within the at least one SL-PRS resource; or
discarding measurements previously made of SL-PRS transmissions within the at least one SL-PRS resource.

14. The method of claim 8, further comprising sending, to at least one sidelink peer UE, a sidelink cancellation indication (SLCI) indicating the at least one SL-PRS resource to be cancelled or rescheduled.

15. The method of claim 8, wherein the at least one SL-PRS resource to be cancelled or rescheduled comprises:
a specific SL-PRS resource;
one occasion of a specific SL-PRS resource set;
all occasions of a specific SL-PRS resource set; or
all SL-PRS resources within a defined window of time.

16. A network entity, comprising:
a memory;
at least one transceiver; and
at least one processor communicatively coupled to the memory and the at least one transceiver, the at least one processor configured to:
determine that at least one sidelink positioning reference signal (SL-PRS) resource should be cancelled or rescheduled; and
send, via the at least one transceiver, to at least one user equipment (UE), a sidelink cancellation indication (SLCI) indicating the at least one SL-PRS resource to be cancelled or rescheduled.

17. The network entity of claim 16, wherein, to determine that at least one SL-PRS resource should be cancelled or rescheduled, the at least one processor is configured to determine that the at least one SL-PRS resource should be used instead for a higher priority uplink, downlink, or sidelink communication.

18. The network entity of claim 16, wherein, to determine that at least one SL-PRS resource should be cancelled or rescheduled, the at least one processor is configured to determine that the at least one SL-PRS resource should be rescheduled instead of cancelled, based on a determination that:
fewer than a configured number of SL-PRS instances were performed;
the at least one SL-PRS resource is part of an on-demand SL-PRS; or
the at least one SL-PRS resource is part of a round-trip time (RTT) pair of measurements.

19. The network entity of claim 16, wherein, to send the SLCI, the at least one processor is configured to send the SLCI as part of downlink control information (DCI).

20. The network entity of claim 16, wherein, to send SLCI to the at least one UE, the at least one processor is configured to send the SLCI to the UE that is configured to transmit SL-PRS signals over the at least one SL-PRS resource.

21. The network entity of claim 20, wherein, to send SLCI to the at least one UE, the at least one processor is configured to send the SLCI to a UE that is configured to receive the SL-PRS signals transmitted over the at least one SL-PRS resource.

22. The network entity of claim 16, wherein the at least one SL-PRS resource to be cancelled or rescheduled comprises:
a specific SL-PRS resource;
one occasion of a specific SL-PRS resource set;
all occasions of a specific SL-PRS resource set: or
all SL-PRS resources within a defined window of time.

23. A user equipment (UE), comprising:
a memory;
at least one transceiver; and
at least one processor communicatively coupled to the memory and the at least one transceiver, the at least one processor configured to:
determine that at least one sidelink positioning reference signal (SL-PRS) resource should be cancelled or rescheduled; and
cancel or reschedule the at least one SL-PRS resource.

24. The UE of claim 23, wherein, to determine that at least one SL-PRS resource should be cancelled or rescheduled, the at least one processor is configured to receive, from a network entity or a sidelink peer UE, a sidelink cancellation indication (SLCI) indicating the at least one SL-PRS resource to be cancelled or rescheduled.

25. The UE of claim 24, wherein, to receive the SLCI, the at least one processor is configured to receive the SLCI via downlink control information (DCI) or sidelink control information (SCI).

26. The UE of claim 23, wherein, to determine that at least one SL-PRS resource should be cancelled or rescheduled, the at least one processor is configured to determine that the at least one SL-PRS resource should be used instead for a higher priority uplink, downlink, or sidelink communication.

27. The UE of claim 23, wherein, to determine that at least one SL-PRS resource should be cancelled or rescheduled, the at least one processor is configured to determine that the at least one SL-PRS resource should be rescheduled instead of cancelled, based on a determination that:
fewer than a configured number of SL-PRS instances were performed;
the at least one SL-PRS resource is part of an on-demand SL-PRS; or
the at least one SL-PRS resource is part of a round-trip time (RTT) pair of measurements.

28. The UE of claim 23, wherein, to cancel or reschedule the at least one SL-PRS resource, the at least one processor is configured to:
cancel SL-PRS transmissions within the at least one SL-PRS resource;
not perform measurements of SL-PRS transmissions within the at least one SL-PRS resource; or
discard measurements previously made of SL-PRS transmissions within the at least one SL-PRS resource.

29. The UE of claim 23, wherein the at least one processor is further configured to send, via the at least one transceiver, to at least one sidelink peer UE, a sidelink cancellation indication (SLCI) indicating the at least one SL-PRS resource to be cancelled or rescheduled.

30. The UE of claim 23, wherein the at least one SL-PRS resource to be cancelled or rescheduled comprises:
a specific SL-PRS resource;
one occasion of a specific SL-PRS resource set;
all occasions of a specific SL-PRS resource set; or
all SL-PRS resources within a defined window of time.
